(19) United States
(12) Patent Application Publication
(10) Pub. No.: US 2024/0346201 A1
(43) Pub. Date: Oct. 17, 2024

(54) METHOD AND APPARATUS FOR PREDICTING SERVICE LIFE OF STEEL BOX GIRDER, DEVICE, AND MEDIUM

(71) Applicant: SOUTHWEST JIAOTONG UNIVERSITY, Chengdu (CN)

(72) Inventor: Jian GUO, Chengdu (CN)

(73) Assignee: SOUTHWEST JIAOTONG UNIVERSITY, Chengdu (CN)

(21) Appl. No.: 18/751,496

(22) Filed: Jun. 24, 2024

Related U.S. Application Data
(63) Continuation of application No. PCT/CN2022/099905, filed on Jun. 20, 2022.

(30) Foreign Application Priority Data
Feb. 18, 2022 (CN) 202210148628.0

(51) Int. Cl. G06F 30/17

(52) U.S. Cl. CPC G06F 30/17

(57) ABSTRACT

A method includes: determining a plurality of stress amplitude ranges based on a plurality of preset discrete stress amplitudes; determining a plurality of dynamic S-N curves based on the plurality of discrete stress amplitudes and an attenuation coefficient of each stress amplitude range, where the attenuation coefficient of each stress amplitude range indicates a degradation degree of material performance of a steel box girder corresponding to each stress amplitude range relative to material performance of a steel box girder corresponding to a previous stress amplitude range; and predicting a service life of a steel box girder based on the plurality of dynamic S-N curves, a plurality of monitored stress amplitudes of the steel box girder, and a plurality of monitoring cycle quantities in a one-to-one correspondence with the plurality of monitored stress amplitudes, where the plurality of monitored stress amplitudes are located in the plurality of stress amplitude ranges.

### CROSS-REFERENCE TO RELATED APPLICATIONS

This disclosure is a continuation of PCT Application PCT/CN2022/099905 filed on Jun. 20, 2022, which is based upon and claims the benefit to CN patent application No. 202210148628.0, filed on Feb. 18, 2022, the entire disclosures of which are incorporated herein by reference in their entireties for all purposes.

### TECHNICAL FIELD

Embodiments of this disclosure relate to the data processing field, and in particular, to a method and an apparatus for predicting a service life of a steel box girder, an electronic device, and a storage medium.

### BACKGROUND

Currently, long-span suspension bridges and cable-stayed bridges that have been built across seas and rivers have basically adopted a form of a steel box girder structure with orthotropic steel bridge plates. A flat steel box girder of the orthotropic steel bridge plate has good structural force-bearing performance and wind resistance, a light weight, small steel consumption, and low costs. The flat steel box girder is widely favored by bridge designers. However, the steel box girder also faces some technical challenges. For example, a fatigue crack failure due to long-term impact of a vehicle load, a wind load, and a temperature load is a prominent problem. This problem greatly affects safety and service performance of an engineering structure.

Currently, a service life of a steel box girder is mainly predicted in two manners. One manner is a nominal stress method in a stress life method commonly used in bridge design specifications in various countries. Update of structural entity information is not considered in this method. The method is a static analysis method. The other manner is a fatigue damage calculation method based on continuous damage mechanics. Impact of a material degradation mechanism on damage accumulation of a steel box girder is not considered in this method.

### SUMMARY

Embodiments of this disclosure provide a method and an apparatus for predicting a service life of a steel box girder, a device, and a storage medium, to improve accuracy of predicting a service life of a steel box girder.

According to a first aspect, an embodiment of this disclosure provides a method for predicting a service life of a steel box girder, including:
determining a plurality of stress amplitude ranges based on a plurality of preset discrete stress amplitudes;
determining a plurality of dynamic S-N curves based on the plurality of discrete stress amplitudes and an attenuation coefficient of each stress amplitude range, where the attenuation coefficient of each stress amplitude range indicates a degradation degree of material performance of a steel box girder corresponding to each stress amplitude range relative to material performance of a steel box girder corresponding to a previous stress amplitude range; and
predicting a service life of a steel box girder based on the plurality of dynamic S-N curves, a plurality of monitored stress amplitudes of the steel box girder, and a plurality of monitoring cycle quantities in a one-to-one correspondence with the plurality of monitored stress amplitudes, where the plurality of monitored stress amplitudes are located in the plurality of stress amplitude ranges.

According to a second aspect, an embodiment of this disclosure further provides an electronic device, including:
one or more processors; and
a memory, configured to store one or more programs.

When the one or more programs are executed by the one or more processors, the one or more processors are enabled to implement the method for predicting a service life of a steel box girder according to the embodiment of this disclosure.

According to a third aspect, an embodiment of this disclosure further provides a computer-readable storage medium. The computer-readable storage medium stores a computer program. When the program is executed by a processor, the method for predicting a service life of a steel box girder according to the embodiment of this disclosure is implemented.

### BRIEF DESCRIPTION OF DRAWINGS

FIG. 1 is a schematic flowchart of a method for predicting a service life of a steel box girder according to an embodiment of this disclosure.

FIG. 2 is a schematic flowchart of another method for predicting a service life of a steel box girder according to an embodiment of this disclosure.

FIG. 3 is a schematic flowchart of still another method for predicting a service life of a steel box girder according to an embodiment of this disclosure.

FIG. 4 is a block diagram of a structure of an apparatus for predicting a service life of a steel box girder according to an embodiment of this disclosure.

FIG. 5 is a schematic diagram of a structure of an electronic device according to an embodiment of this disclosure.

### DESCRIPTION OF EMBODIMENTS

Embodiments of this disclosure will be described in more detail below with reference to the accompanying drawings. Although some embodiments of this disclosure are illustrated in the accompanying drawings, it should be understood that this disclosure may be implemented in various forms and should not be construed as being limited to the embodiments set forth herein. Rather, these embodiments are provided for a more thorough and complete understanding of this disclosure. It should be understood that the accompanying drawings and embodiments of this disclosure are for illustrative purposes only, and are not intended to limit the scope of protection of this disclosure.

It should be understood that steps recorded in method implementations of this disclosure may be performed in different orders and/or performed in parallel. In addition, the method implementations may include additional steps and/or omit the shown steps. The scope of this disclosure is not limited in this aspect.

The term “include” and its variants used in this specification indicate open inclusion, that is, “include but is not limited to”. The term “based on” means “at least partially based on”. The term “one embodiment” means “at least one embodiment”. The term “another embodiment” means “at least one another embodiment”. The term “some embodiments” means “at least some embodiments”. Related definitions of other terms are provided in the following descriptions.

It should be noted that modifiers of “one” and “a plurality of” mentioned in this disclosure are exemplary instead of non-restrictive. The modifiers should be understood as “one or more” unless otherwise specified in the context.

Currently, a service life of a steel box girder is mainly predicted in two manners.

A first manner is a nominal stress method in a stress life method commonly used in bridge design specifications in various countries. In the nominal stress method, it is considered that, based on a Woehler curve (an S-N curve), for any component or structural detail, components or structural details have the same fatigue life as long as they have the same manufacturing material and the same stress concentration coefficient K and have consistent load spectrums. In this method, a nominal stress is a control parameter. This method is also referred to as the nominal stress method (an S-N curve method), and is an earliest method used to evaluate a total fatigue life of a part. This method is mainly applicable to estimation of a low-stress long-life problem, that is, high-cycle fatigue. When this method is used, an S-N curve of a part is obtained through correction performed based on an S-N curve of a material in consideration of impact of various factors. The fatigue life of the part is obtained based on the nominal stress of the part. This method is simple and convenient to use. In addition, a large amount of S-N curve data is accumulated and is still widely used. Using the nominal stress method to estimate a fatigue life of a part is centered on the Palmgren-Miner linear cumulative damage rule. The fatigue life of the part under a single-level constant-amplitude alternating stress can be obtained through querying an S-N curve at a corresponding stress level. Fatigue life estimation under a multi-level constant-amplitude alternating stress, a variable-amplitude stress, and a random stress needs to be performed based on the fatigue cumulative damage theory. When a alternating stress above a fatigue limit is applied, it is assumed that stress cycles are independent of each other, and each alternating stress causes a specific permanent damage. This damage can be linearly superposed. Destruction occurs when a critical value is reached. Under a multi-level stress, when a total damage D is accumulated to 1, a fatigue damage occurs on the part.

A second manner is the fatigue damage calculation method based on continuous damage mechanics. A crack propagation depth is obtained through calculation based on linear elastic fracture mechanics. A fatigue damage is directly obtained by dividing the crack propagation depth and a member thickness. The expert Fisher analyzes, for the first time, fatigue and fracture instances of a plurality of steel bridges by using a fracture mechanics method, and establishes a relationship among parameters such as a crack size, a stress, a detail geometric shape, crack propagation, and material toughness, which provides a valuable reference for further understanding importance of structural characteristics, a detail design, and welding quality. Fatigue failure instances of a large quantity of welded steel bridges indicate that all fatigue cracks originate from initial defects in the detail. Therefore, a fracture mechanics fatigue life analysis method that acknowledges that initial defects exist in structural details has an unparalleled advantage in comparison with a conventional fatigue analysis method. A fatigue crack life mainly includes two parts: (1) a crack initiation stage in which a 10⁻⁴ mm to 0.2 mm crack is formed in the detail under a cyclic load; and (2) a crack propagation stage in which the crack develops from the initiation to a critical crack size. For steel bridge welding details, due to a limitation of a precision requirement of a manufacturing process, a relatively large initial defect (from 0.02 mm to 0.2 mm) usually exists in a welding detail. Therefore, it is considered that there is no crack initiation stage. In other words, a fatigue life of a steel bridge detail includes only the crack propagation stage. In this case, a key task of fatigue life evaluation based on fracture mechanics is to study a fatigue crack propagation rule and a fatigue crack propagation life calculation model under an initial defect condition.

For a fatigue problem of steel box girders, an S-N theoretical analysis and test analysis framework established in the existing technical solutions is a static idea that does not take account of individual information update of a structure. In fact, in a service period of decades or even hundreds of years, a decrease of a strength of an orthotropic steel bridge plate is a result of continuous random action of a time-varying stress on the bridge plate. A strength state of a component at any moment is related to a state at a previous moment. If a bridge plate of a steel box girder is used as a time-varying structural system affected by a random external load, a state at a next moment of system evolution is related to a current moment. A fatigue model of the system is a dynamic time-varying evolution process. In the existing technical solutions, time-varying state analysis of the steel box girder system cannot be considered.

A damage accumulation process in a fatigue damage process of the steel box girder is mainly manifested as irreversible degradation of material performance. In conventional methods, a large quantity of constant-amplitude fatigue experiments are conducted for various details of steel bridges. The fatigue of the steel box girder is in a fatigue range featured by a variable amplitude, a low stress, and a high cycle. Most stress amplitudes are far lower than the constant-amplitude fatigue limit. When an anti-fatigue design is implemented according to standards, a problem of a fatigue damage of the steel box girder does not occur. However, a fatigue crack is generated in an actual operation process of the steel box girder, mainly because irreversible degradation of material performance occurs during actual operation of the steel box girder. In the conventional technologies, impact of a material degradation mechanism on fatigue damage accumulation of the steel box girder is insufficiently considered.

In the existing technical solutions, it is considered that a stress pulse lower than a constant-amplitude fatigue limit does not produce a fatigue damage effect. In fact, for steel bridge details with variable-amplitude fatigue, even if an equivalent stress pulse is lower than the constant-amplitude fatigue limit, fatigue crack propagation may still occur provided that several stress pulses are greater than the constant-amplitude fatigue limit in few cycles. In this case, those low stress pulses lower than the constant-amplitude fatigue limit actually generate fatigue damages. In a conventional method, a fatigue performance change exceeding a non-constant stress amplitude range is used. Consequently, it is difficult to reflect a feature of non-linear accumulation of fatigue damages, and a fatigue damage of a welded steel structure cannot be accurately evaluated.

To overcome the foregoing defects in the conventional technologies, this disclosure provides a method for predicting a service life of a steel box girder.

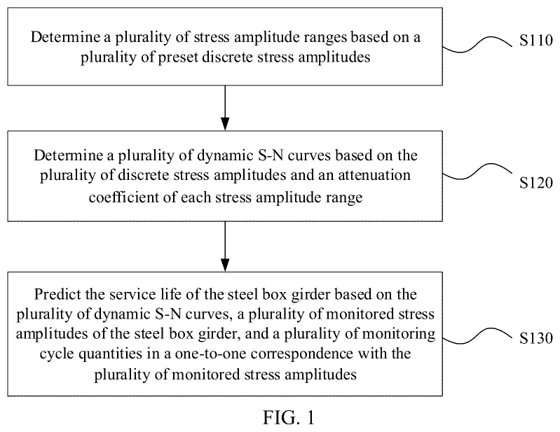

FIG. 1 is a schematic flowchart of a method for predicting a service life of a steel box girder according to an embodiment of this disclosure. The method may be performed by an apparatus for predicting a service life of a steel box girder. The apparatus may be implemented by software and/or hardware, and may be configured in an electronic device. The method for predicting a service life of a steel box girder according to this embodiment of this disclosure is applicable to a scenario of predicting a service life of a steel box girder. As shown in FIG. 1, the method for predicting a service life of a steel box girder provided in this embodiment may include the following steps.

S110: Determine a plurality of stress amplitude ranges based on a plurality of preset discrete stress amplitudes.

In this embodiment, the plurality of preset discrete stress amplitudes may be a plurality of inconsecutive stress amplitude boundaries determined by a designer according to experience. A purpose of determining the plurality of stress amplitude ranges is to divide, into a plurality of sub-ranges, a total stress amplitude range that can be born by a steel box girder, to determine a dynamic S-N curve corresponding to each stress amplitude range in stages, thereby implementing dynamic prediction of a service life of the steel box girder.

The determining a plurality of stress amplitude ranges based on a plurality of preset discrete stress amplitudes includes: sorting the plurality of discrete stress amplitudes in sequence by numerical magnitude; and in a sorting result, using every two adjacent discrete stress amplitudes as boundary values of one stress amplitude range, to obtain the plurality of stress amplitude ranges.

S120: Determine a plurality of dynamic S-N curves based on the plurality of discrete stress amplitudes and an attenuation coefficient of each stress amplitude range.

The attenuation coefficient of each stress amplitude range indicates a degradation degree of material performance of a steel box girder corresponding to each stress amplitude range relative to material performance of a steel box girder corresponding to a previous stress amplitude range.

In this embodiment, the attenuation coefficient is introduced in consideration of irreversible degradation of material performance in a damage accumulation process of the steel box girder. Each stress amplitude range corresponds to one attenuation coefficient. The attenuation coefficient is used to reflect the degradation degree of the material performance of the steel box girder corresponding to the current stress amplitude range relative to the material performance of the steel box girder corresponding to the adjacent previous stress amplitude range. The degradation degree may reflect a slope change degree of two dynamic S-N curves corresponding to two adjacent stress amplitude ranges. Therefore, a slope of a dynamic S-N curve corresponding to each stress amplitude range may be calculated based on the attenuation coefficient.

The dynamic S-N curve may be determined based on a slope of a dynamic S-N curve corresponding to each stress amplitude range and a point on the dynamic S-N curve. The point on the dynamic S-N curve may be a point determined based on a boundary stress amplitude (that is, a discrete stress amplitude) of the stress amplitude range and a current cycle quantity corresponding to the boundary stress amplitude.

S130: Predict the service life of the steel box girder based on the plurality of dynamic S-N curves, a plurality of monitored stress amplitudes of the steel box girder, and a plurality of monitoring cycle quantities in a one-to-one correspondence with the plurality of monitored stress amplitudes.

The plurality of monitored stress amplitudes are located in the plurality of stress amplitude ranges.

After a model of the plurality of dynamic S-N curves is determined, a sensor is installed in a fatigue vulnerability region of the steel box girder in this embodiment. Monitored data of the sensor is obtained. The plurality of monitored stress amplitudes of the steel box girder and the plurality of monitoring cycle quantities in the one-to-one correspondence with the plurality of monitored stress amplitudes are determined based on the monitored data. The service life of the steel box girder is determined based on the plurality of determined dynamic S-N curves and the actual monitored data of the steel box girder.

Before the predicting the service life of the steel box girder based on the plurality of dynamic S-N curves, a plurality of monitored stress amplitudes of the steel box girder, and a plurality of monitoring cycle quantities in a one-to-one correspondence with the plurality of monitored stress amplitudes, the method further includes: determining the fatigue vulnerability region of the steel box girder; obtaining a plurality of pieces of monitored data monitored by the sensor installed in the fatigue vulnerability region; and performing preset algorithm processing on the plurality of pieces of monitored data, to obtain the plurality of monitored stress amplitudes and the plurality of monitoring cycle quantities in the one-to-one correspondence with the plurality of monitored stress amplitudes.

In this embodiment, a structural parameter of a bridge is obtained. A finite element full-bridge model and a finite element sub-model are established based on the structural parameter. The fatigue vulnerability region of the steel box girder is determined based on the finite element full-bridge model and the finite element sub-model. Determining the fatigue vulnerability region of the steel box girder based on the finite element full-bridge model and the finite element sub-model may include: determining a load condition, for example, selecting a most adverse load condition to perform statics analysis; under the load condition, determining, based on the finite element full-bridge model and the finite element sub-model, a plurality of stress amplitudes respectively corresponding to a plurality of regions in the steel box girder, where the plurality of stress amplitudes may be represented by using a stress nephogram and a strain nephogram; and using, as the fatigue vulnerability region, a region corresponding to a maximum value of the plurality of stress amplitudes respectively corresponding to the plurality of regions. For example, the fatigue vulnerability region is a longitudinal rib butt weld of the steel box girder.

After the fatigue vulnerability region of the steel box girder is determined, a strain sensor is installed in the fatigue vulnerability region to obtain a plurality of strain values obtained through monitoring performed by the strain sensor. A plurality of stress values can be obtained by separately multiplying the plurality of strain values by an elastic modulus. A plurality of candidate monitored stress amplitudes and candidate monitoring cycle quantities in a one-to-one correspondence with the plurality of candidate monitored stress amplitudes are determined based on a rainflow-counting algorithm and the plurality of stress values. A plurality of monitored stress amplitudes are selected from the plurality of candidate monitored stress amplitudes. Therefore, the plurality of monitored stress amplitudes are located in the plurality of stress amplitude ranges.

The method for predicting a service life of a steel box girder according to this embodiment includes: determining the plurality of stress amplitude ranges based on the plurality of preset discrete stress amplitudes; determining the plurality of dynamic S-N curves based on the plurality of discrete stress amplitudes and the attenuation coefficient of each stress amplitude range, where the attenuation coefficient of each stress amplitude range indicates the degradation degree of the material performance of the steel box girder corresponding to each stress amplitude range relative to the material performance of the steel box girder corresponding to the previous stress amplitude range; and predicting the service life of the steel box girder based on the plurality of dynamic S-N curves, the plurality of monitored stress amplitudes of the steel box girder, and the plurality of monitoring cycle quantities in the one-to-one correspondence with the plurality of monitored stress amplitudes, where the plurality of monitored stress amplitudes are located in the plurality of stress amplitude ranges. In this embodiment of this disclosure, a dynamic S-N curve is established by introducing an attenuation coefficient, and damage accumulation of an orthotropic steel bridge plate is further calculated to predict a fatigue life of a steel box girder. In this way, a limitation of conventional technologies in a field of predicting a fatigue life of a steel box girder is overcome, to effectively and accurately predict the fatigue life of the steel box girder.

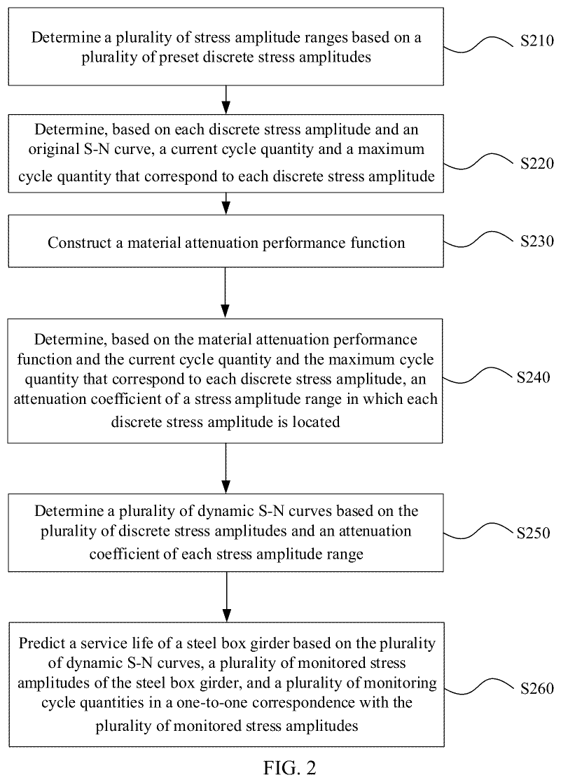

FIG. 2 is a schematic flowchart of another method for predicting a service life of a steel box girder according to an embodiment of this disclosure. The solution in this embodiment may be combined with one or more optional solutions in the foregoing embodiment. As shown in FIG. 2, the method for predicting a service life of a steel box girder provided in this embodiment may include the following steps.

S210: Determine a plurality of stress amplitude ranges based on a plurality of preset discrete stress amplitudes.

The plurality of discrete stress amplitudes are sorted in sequence by numerical magnitude. In a sorting result, every two adjacent discrete stress amplitudes are used as boundary values of one stress amplitude range, to obtain the plurality of stress amplitude ranges. In other words, the plurality of discrete stress amplitudes are used as boundary stress amplitudes of the plurality of stress amplitude ranges.

In an embodiment, the stress amplitude is denoted as σ. There are three discrete stress amplitudes that are respectively σ₁, σ₂, and σ₃ in ascending order. Two stress amplitude ranges may be determined based on σ₁, σ₂, and σ₃, that is, σ₁<σ<σ₂ and σ₂<σ<σ₃ respectively.

S220: Determine, based on each discrete stress amplitude and an original S-N curve, a current cycle quantity and a maximum cycle quantity that correspond to each discrete stress amplitude.

The original S-N curve is a Woehler curve based on a nominal stress method in the conventional technologies. An appropriate original S-N curve is selected based on parameters of the steel box girder. The current cycle quantity and the maximum cycle quantity that correspond to each discrete stress amplitude are determined based on the discrete stress amplitude and the original S-N curve.

In an embodiment, for the discrete stress amplitudes: σ₁, σ₂, and σ₃, based on the original S-N curve, a current cycle quantity corresponding to σ₁ is determined as η₁, and a maximum cycle quantity corresponding to σ₁ is N_{f1}; a current cycle quantity corresponding to σ₂ is determined as η₂, and a maximum cycle quantity corresponding to σ₂ is N_{f2}; and a current cycle quantity corresponding to σ₃ is determined as η₃, and a maximum cycle quantity corresponding to σ₃ is N_{f3}.

S230: Construct a material attenuation performance function.

$$M ( n ) = ( C - D ) {e}^{- \frac{n}{{N}_{f}}} + D$$

Herein, M(n) is material attenuation performance, C is initial material performance, D is an attenuation function, N_{f} is a maximum cycle quantity corresponding to a stress amplitude, n is a current cycle quantity corresponding to the stress amplitude σ, 0<n<N_{f}, and e is a constant.

S240: Determine, based on the material attenuation performance function and the current cycle quantity and the maximum cycle quantity that correspond to each discrete stress amplitude, an attenuation coefficient of a stress amplitude range in which each discrete stress amplitude is located.

$$β = \frac{M ( n ) - M ( {N}_{f} )}{M ( O ) - M ( {N}_{f} )} = \frac{[ ( C - D ) {e}^{- \frac{n}{{N}_{f}}} + D ] - [ ( C - D ) {e}^{- 1} + D ]}{C - [ ( C - D ) {e}^{- 1} + D ]} = \frac{{e}^{- \frac{n}{{N}_{f}}} - {e}^{- 1}}{1 - {e}^{- 1}} .$$

Herein, β is an attenuation coefficient of a stress amplitude range in which the stress amplitude σ is located.

In an embodiment, an attenuation coefficient of the stress amplitude range σ₁<α<σ₂ is that

$${β}_{1} == \frac{{e}^{- \frac{{n}_{2}}{{N}_{f 2}}} - {e}^{- 1}}{1 - {e}^{- 1}} ;$$

and an attenuation coefficient of the stress amplitude range σ₂<σ<σ₃ is that

$${β}_{2} == \frac{{e}^{- \frac{{n}_{3}}{{N}_{f 3}}} - {e}^{- 1}}{1 - {e}^{- 1}} .$$

S250: Determine a plurality of dynamic S-N curves based on the plurality of discrete stress amplitudes and an attenuation coefficient of each stress amplitude range.

The attenuation coefficient of each stress amplitude range indicates a degradation degree of material performance of a steel box girder corresponding to each stress amplitude range relative to material performance of a steel box girder corresponding to a previous stress amplitude range.

In this embodiment, a slope change rate of two dynamic S-N curves corresponding to a current stress amplitude range and a previous stress amplitude range is represented by an attenuation coefficient of the current stress amplitude range. It should be noted that when the current stress amplitude range is a first stress amplitude range obtained through division, a slope of a dynamic S-N curve corresponding to the first stress amplitude range is determined based on an attenuation coefficient of the first stress amplitude range and a slope of the original S-N curve.

In an embodiment, the slope of the original S-N curve is b (a known quantity), a slope of a dynamic S-N curve corresponding to the stress amplitude range σ₁<σ<σ₂ is b₁, and a slope of a dynamic S-N curve corresponding to the stress amplitude range σ₂<σ<σ₃ is b₂. In this case,

$$\frac{b}{{b}_{1}} = {β}_{1} , and = \frac{b}{{b}_{2}} = \frac{b}{{b}_{1}} \times \frac{{b}_{1}}{{b}_{2}} = {β}_{1} \times {β}_{2} .$$

When a quantity of determined stress amplitude ranges is i,

$$\frac{b}{{b}_{i}} = \frac{b}{{b}_{1}} \times \frac{{b}_{1}}{{b}_{2}} \times … \times \frac{{b}_{i - 3}}{{b}_{i - 2}} \times \frac{{b}_{i - 2}}{{b}_{i - 1}} \times \frac{{b}_{i - 1}}{{b}_{i}} = {β}_{1} \times {β}_{2} \times … \times {β}_{i - 2} \times {β}_{i - 1} \times {β}_{i} .$$

Herein, (σ₂, η₂) is located on the dynamic S-N curve corresponding to the stress amplitude range σ₁<σ<σ₂, and (σ₃, η₃) is located on the dynamic S-N curve corresponding to the stress amplitude range σ₂<σ<₃.

S260: Predict the service life of the steel box girder based on the plurality of dynamic S-N curves, a plurality of monitored stress amplitudes of the steel box girder, and a plurality of monitoring cycle quantities in a one-to-one correspondence with the plurality of monitored stress amplitudes.

The plurality of monitored stress amplitudes are located in the plurality of stress amplitude ranges.

In this embodiment, the service life of the steel box girder is determined based on the plurality of determined dynamic S-N curves and actual monitoring data of the steel box girder.

In the method for predicting a service life of a steel box girder provided in this embodiment, a specific expression form of an attenuation coefficient is provided. The attenuation coefficient is determined, so that a slope of each dynamic S-N curve can be obtained. In this way, the finally determined service life of the steel box girder takes account of impact of a material performance attenuation factor, thereby improving accuracy of the determined service life of the steel box girder.

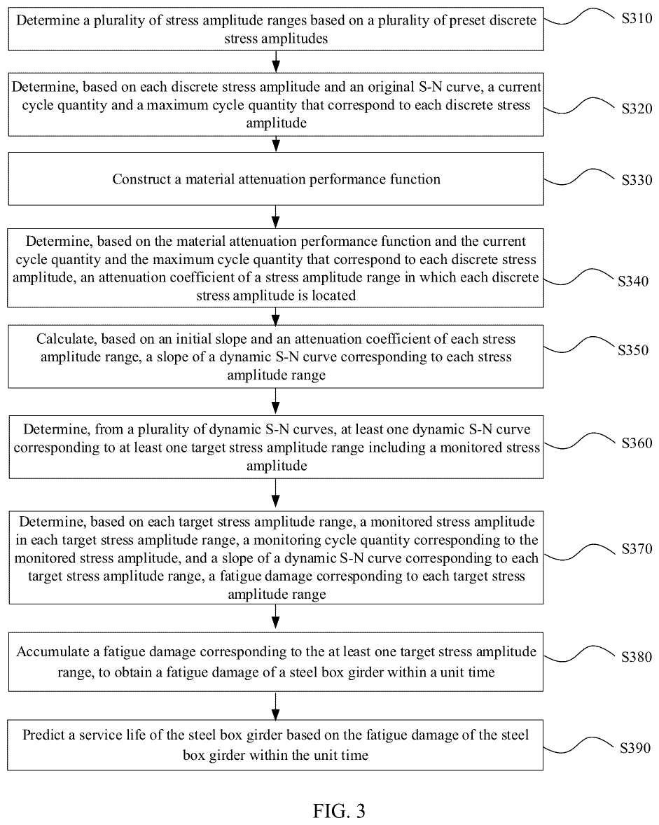

FIG. 3 is a schematic flowchart of still another method for predicting a service life of a steel box girder according to an embodiment of this disclosure. The solution in this embodiment may be combined with one or more optional solutions in the foregoing embodiment. As shown in FIG. 3, the method for predicting a service life of a steel box girder provided in this embodiment may include the following steps.

S310: Determine a plurality of stress amplitude ranges based on a plurality of preset discrete stress amplitudes.

In an embodiment, the stress amplitude is denoted as σ. There are three discrete stress amplitudes that are respectively σ₁, σ₂, and σ₃ in ascending order. Two stress amplitude ranges may be determined based on σ₁, σ₂, and σ₃, that is, σ₁<σ≤σ₂ and σ₂<σ≤σ₃ respectively.

S320: Determine, based on each discrete stress amplitude and an original S-N curve, a current cycle quantity and a maximum cycle quantity that correspond to each discrete stress amplitude.

For the discrete stress amplitudes: σ₁, σ₂, and σ₃, based on the original S-N curve, a current cycle quantity corresponding to σ₁ is determined as η₁, and a maximum cycle quantity corresponding to σ₁ is N_{f1}; a current cycle quantity corresponding to σ₂ is determined as η₂, and a maximum cycle quantity corresponding to σ₂ is N_{f2}; and a current cycle quantity corresponding to Us is determined as η₃, and a maximum cycle quantity corresponding to σ₃ is N_{f3}.

S330: Construct a material attenuation performance function.

$$M ( n ) = ( C - D ) {e}^{- \frac{n}{{N}_{f}}} + D .$$

Herein, M(n) is material attenuation performance, C is initial material performance, D is an attenuation function, N_{f} is a maximum cycle quantity corresponding to a stress amplitude, n is a current cycle quantity corresponding to the stress amplitude σ, 0≤n≤N_{f}, and e is a constant.

S340: Determine, based on the material attenuation performance function and the current cycle quantity and the maximum cycle quantity that correspond to each discrete stress amplitude, an attenuation coefficient of a stress amplitude range in which each discrete stress amplitude is located.

$$β = \frac{M ( n ) - M ( {N}_{f} )}{M ( 0 ) - M ( {N}_{f} )} = \frac{[ ( C - D ) {e}^{\frac{- n}{{N}_{f}}} + D ] - [ ( C - D ) {e}^{- 1} + D ]}{C - [ ( C - D ) {e}^{- 1} + D ]} = \frac{{e}^{\frac{- n}{{N}_{f}}} - {e}^{- 1}}{1 - {e}^{- 1}} .$$

Herein, β is an attenuation coefficient of a stress amplitude range in which the stress amplitude σ is located.

An attenuation coefficient of the stress amplitude range σ₁<σ≤σ₂ is that

$${β}_{1} == \frac{{e}^{- \frac{{n}_{2}}{{N}_{f 2}}} - {e}^{- 1}}{1 - {e}^{- 1}} ;$$

and an attenuation coefficient of the stress amplitude range σ₂<σ≤σ₃ is that

$${β}_{2} == \frac{{e}^{- \frac{{n}_{3}}{{N}_{f 3}}} - {e}^{- 1}}{1 - {e}^{- 1}} .$$

S350: Calculate, based on an initial slope and an attenuation coefficient of each stress amplitude range, a slope of a dynamic S-N curve corresponding to each stress amplitude range.

The initial slope is a slope b (a known quantity) of the original S-N curve. A point determined based on each discrete stress amplitude and the current cycle quantity corresponding to each discrete stress amplitude is located on a dynamic S-N curve corresponding to the stress amplitude range in which each discrete stress amplitude is located.

A slope change rate of two dynamic S-N curves corresponding to each stress amplitude range and a previous stress amplitude range is represented by an attenuation coefficient of each stress amplitude range.

A slope of a dynamic S-N curve corresponding to the stress amplitude range σ₁<σ≤σ₂ is b₁, and a slope of a dynamic S-N curve corresponding to the stress amplitude range σ₂<σ<σ₃ is b₂. In this case,

$$\frac{b}{{b}_{1}} = {β}_{1} , and$$

$$\frac{b}{{b}_{2}} = \frac{b}{{b}_{1}} \times \frac{{b}_{1}}{{b}_{2}} = {β}_{1} \times {β}_{2} .$$

When a quantity of determined stress amplitude ranges is i,

$$\frac{b}{{b}_{i}} = \frac{b}{{b}_{1}} \times \frac{{b}_{1}}{{b}_{2}} \times … \times \frac{{b}_{i - 3}}{{b}_{i - 2}} \times \frac{{b}_{i - 2}}{{b}_{i - 1}} \times \frac{{b}_{i - 1}}{{b}_{i}} = {β}_{1} \times {β}_{2} \times … \times {β}_{i - 2} \times {β}_{i - 1} \times {β}_{i} .$$

Herein, (σ₂, η₂) is located on the dynamic S-N curve corresponding to the stress amplitude range σ₁<σ≤σ₂, and (σ₃, η₃) is located on the dynamic S-N curve corresponding to the stress amplitude range σ₂<σ≤σ₃.

S360: Determine, from the plurality of dynamic S-N curves, at least one dynamic S-N curve corresponding to at least one target stress amplitude range including a monitored stress amplitude.

In this embodiment, m target stress amplitude ranges including a monitored stress amplitude need to be selected from the i stress amplitude ranges, where m is a positive integer greater than 0 and less than or equal to i. Dynamic S-N curves corresponding to the target stress amplitude ranges are determined.

S370: Determine, based on each target stress amplitude range, a monitored stress amplitude in each target stress amplitude range, a monitoring cycle quantity corresponding to the monitored stress amplitude, and a slope of a dynamic S-N curve corresponding to each target stress amplitude range, a fatigue damage corresponding to each target stress amplitude range.

A formula for calculating the fatigue damage corresponding to the target stress amplitude range is as follows:

$${D}_{j} = {\sum }_{k = 1}^{l} \frac{{N}_{k} {S}_{k}^{{b}_{j}}}{{K}_{j}} , {σ}_{j} < {S}_{k} \leq {σ}_{j + 1} .$$

Herein, Dⱼ is a fatigue damage corresponding to j^{th} target stress amplitude range, Sₖ is a k^{th} monitored stress amplitude in the j^{th} target stress range, Nₖ is a monitoring cycle quantity corresponding to Sₖ, l is a total quantity of monitored stress amplitudes in the j^{th} target stress range, and Kⱼ is a fatigue strength coefficient corresponding to the j^{th} target stress amplitude range, Kⱼ=σⱼ₊₁^{b}^{ⱼ}·2×10⁶, bⱼ is a slope of a dynamic S-N curve corresponding to the j^{th} target stress amplitude range, and (σⱼ, σⱼ₊₁] target stress amplitude range.

S380: Accumulate a fatigue damage corresponding to the at least one target stress amplitude range, to obtain a fatigue damage of the steel box girder within a unit time.

The fatigue damage of the steel box girder within the unit time is as follows:

$$D = {\sum }_{j = 1}^{m} {D}_{j} = {\sum }_{j = 1}^{m} {\sum }_{k = 1}^{l} \frac{{N}_{k} {S}_{k}^{{b}_{j}}}{{K}_{j}} , {σ}_{j} < {S}_{k} \leq {σ}_{j + 1} .$$

In an embodiment, the fatigue damage of the steel box girder within the unit time may be alternatively set as follows:

$$D = {\sum }_{p = 1}^{q} \frac{{N}_{p} {S}_{p}^{b}}{K} + {\sum }_{j = 1}^{m} {D}_{j} = {\sum }_{p = 1}^{q} \frac{{N}_{p} {S}_{p}^{b}}{K} + {\sum }_{j = 1}^{m} {\sum }_{k = 1}^{l} \frac{{N}_{k} {S}_{k}^{{b}_{j}}}{{K}_{j}} ,$$

$${S}_{p} \leq {σ}_{1} , {σ}_{j} < {S}_{k} \leq {σ}_{j + 1} .$$

Herein, S_{P} is a P^{th} monitored stress amplitude in a stress amplitude range less than or equal to σ₁, N_{P} is a monitoring cycle quantity corresponding to S_{P}, q is a total quantity of monitored stress amplitudes in the stress amplitude range less than or equal to σ₁, K is a fatigue strength coefficient corresponding to the stress amplitude range less than or equal to σ₁, K=σ₁^{b}·2×10⁶, and b is the slope of the original S-N curve.

In the foregoing formula, a fatigue damage corresponding to the stress amplitude range less than or equal to σ₁ is further considered, so that the determined fatigue damage of the steel box girder within the unit time is more accurate.

S390: Predict the service life of the steel box girder based on the fatigue damage of the steel box girder within the unit time.

In this embodiment, when the unit time is one day, the service life of the steel box girder is as follows:

$$T = \frac{1}{365 D} .$$

Herein, T is the service life of the steel box girder.

It may be understood that the foregoing formula may be adaptively adjusted when the unit time takes another value.

In the method for predicting a service life of a steel box girder provided in this embodiment, a specific expression form of calculating the fatigue damage and the service life of the steel box girder is provided. A material degradation degree of the steel box girder and actual monitored data are comprehensively considered, so that the determined service life of the steel box girder is more accurate.

In this embodiment of this disclosure, for the first time, a bridge plate of the steel box girder is used as a time-varying structural system affected by a random external load. A dynamic S-N curve of the structure is obtained based on the original S-N curve. Based on the proposed technical solutions, a remaining life of the steel box girder can be more accurately predicted. In this embodiment of this disclosure, the attenuation coefficient is introduced in consideration of irreversible degradation of material performance in a damage accumulation process of the steel box girder. By using the technical solutions, life prediction accuracy of a steel box girder in a design process can be greatly improved, thereby ensuring accuracy of fatigue calculation.

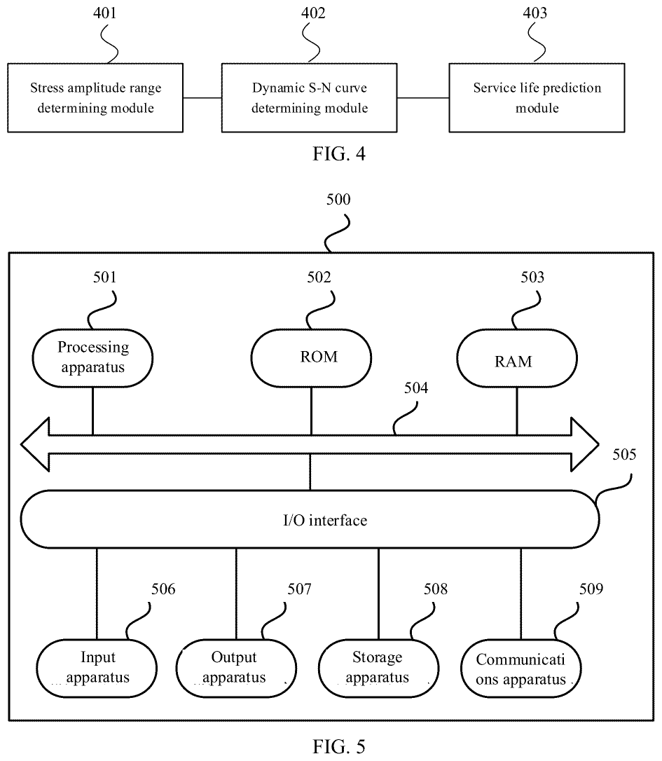

FIG. 4 is a block diagram of a structure of an apparatus for predicting a service life of a steel box girder according to an embodiment of this disclosure. The apparatus may be implemented by software and/or hardware, may be configured in an electronic device, and may be configured to predict a service life of a steel box girder by using a method for predicting a service life of a steel box girder. As shown in FIG. 4, the apparatus for predicting a service life of a steel box girder provided in this embodiment may include a stress amplitude range determining module 401, a dynamic S-N curve determining module 402, and a service life prediction module 403.

The stress amplitude range determining module 401 is configured to determine a plurality of stress amplitude ranges based on a plurality of preset discrete stress amplitudes.

The dynamic S-N curve determining module 402 is configured to determine a plurality of dynamic S-N curves based on the plurality of discrete stress amplitudes and an attenuation coefficient of each stress amplitude range. The attenuation coefficient of each stress amplitude range indicates a degradation degree of material performance of a steel box girder corresponding to each stress amplitude range relative to material performance of a steel box girder corresponding to a previous stress amplitude range.

The service life prediction module 403 is configured to predict a service life of a steel box girder based on the plurality of dynamic S-N curves, a plurality of monitored stress amplitudes of the steel box girder, and a plurality of monitoring cycle quantities in a one-to-one correspondence with the plurality of monitored stress amplitudes. The plurality of monitored stress amplitudes are located in the plurality of stress amplitude ranges.

The apparatus for predicting a service life of a steel box girder provided in this embodiment determines the plurality of stress amplitude ranges based on the plurality of preset discrete stress amplitudes; determines the plurality of dynamic S-N curves based on the plurality of discrete stress amplitudes and the attenuation coefficient of each stress amplitude range, where the attenuation coefficient of each stress amplitude range indicates the degradation degree of the material performance of the steel box girder corresponding to each stress amplitude range relative to the material performance of the steel box girder corresponding to the previous stress amplitude range; and predicts the service life of the steel box girder based on the plurality of dynamic S-N curves, the plurality of monitored stress amplitudes of the steel box girder, and the plurality of monitoring cycle quantities in a one-to-one correspondence with the plurality of monitored stress amplitudes, where the plurality of monitored stress amplitudes are located in the plurality of stress amplitude ranges. In this embodiment of this disclosure, the dynamic S-N curve is established by introducing the attenuation coefficient, and damage accumulation of an orthotropic steel bridge plate is further calculated to predict a fatigue life of the steel box girder. In this way, a limitation of conventional technologies in a field of predicting a fatigue life of a steel box girder is overcome, to effectively and accurately predict the fatigue life of the steel box girder.

Based on the foregoing solutions, the apparatus for predicting a service life of a steel box girder further includes:
a cycle quantity determining module, configured to determine, based on each discrete stress amplitude and an original S-N curve, a current cycle quantity and a maximum cycle quantity that correspond to each discrete stress amplitude;
a function construction module, configured to construct a material attenuation performance function; and
an attenuation coefficient determining module, configured to determine, based on the material attenuation performance function and the current cycle quantity and the maximum cycle quantity that correspond to each discrete stress amplitude, an attenuation coefficient of a stress amplitude range in which each discrete stress amplitude is located.

Based on the foregoing solutions, the function construction module is specifically configured to implement the following:

$$M ( n ) = ( C - D ) {e}^{- \frac{n}{{N}_{f}}} + D .$$

Herein, M(n) is material attenuation performance, C is initial material performance, D is an attenuation function, N_{f} is a maximum cycle quantity corresponding to a stress amplitude, n is a current cycle quantity corresponding to the stress amplitude, 0≤n≤N_{f}, and e is a constant.

Based on the foregoing solutions, the attenuation coefficient determining module is specifically configured to implement the following:

$$β = \frac{M ( n ) - M ( {N}_{f} )}{M ( 0 ) - M ( {N}_{f} )} = \frac{[ ( C - D ) {e}^{\frac{- n}{{N}_{f}}} + D ] - [ ( C - D ) {e}^{- 1} + D ]}{C - [ ( C - D ) {e}^{- 1} + D ]} = \frac{{e}^{\frac{- n}{{N}_{f}}} - {e}^{- 1}}{1 - {e}^{- 1}} .$$

Herein, β is an attenuation coefficient of a stress amplitude range in which the stress amplitude is located.

Based on the foregoing solutions, the dynamic S-N curve determining module is 402 specifically configured to:
calculate, based on an initial slope and an attenuation coefficient of each stress amplitude range, a slope of a dynamic S-N curve corresponding to each stress amplitude range.

The initial slope is a slope of the original S-N curve. A point determined based on each discrete stress amplitude and the current cycle quantity corresponding to each discrete stress amplitude is located on a dynamic S-N curve corresponding to the stress amplitude range in which each discrete stress amplitude is located.

Based on the foregoing solutions, a slope change rate of two dynamic S-N curves corresponding to each stress amplitude range and a previous stress amplitude range is represented by an attenuation coefficient of each stress amplitude range.

Based on the foregoing solutions, the service life prediction module 403 is specifically configured to:
determine, from the plurality of dynamic S-N curves, at least one dynamic S-N curve corresponding to at least one target stress amplitude range including a monitored stress amplitude;
determine, based on each target stress amplitude range, a monitored stress amplitude in each target stress amplitude range, a monitoring cycle quantity corresponding to the monitored stress amplitude, and a slope of a dynamic S-N curve corresponding to each target stress amplitude range, a fatigue damage corresponding to each target stress amplitude range;
accumulate a fatigue damage corresponding to the at least one target stress amplitude range, to obtain a fatigue damage of the steel box girder within a unit time; and
predict the service life of the steel box girder based on the fatigue damage of the steel box girder within the unit time.

Based on the foregoing solutions, the apparatus for predicting a service life of a steel box girder further includes a monitoring module, configured to: determine a fatigue vulnerability region of the steel box girder; obtain a plurality of pieces of monitored data monitored by a sensor installed in the fatigue vulnerability region; and perform preset algorithm processing on the plurality of pieces of monitored data, to obtain the plurality of monitored stress amplitudes and the plurality of monitoring cycle quantities in the one-to-one correspondence with the plurality of monitored stress amplitudes.

Based on the foregoing solutions, the stress amplitude range determining module 401 is specifically configured to:
sort the plurality of discrete stress amplitudes in sequence by numerical magnitude; and in the sorting result, use every two adjacent discrete stress amplitudes as boundary values of one stress amplitude range, to obtain the plurality of stress amplitude ranges.

The apparatus for predicting a service life of a steel box girder provided in this embodiment of this disclosure can perform the method for predicting a service life of a steel box girder provided in any embodiment of this disclosure, and has corresponding functional modules and beneficial effects for performing the method for predicting a service life of a steel box girder. For technical details not exhaustively described in this embodiment, refer to the method for predicting a service life of a steel box girder provided in any embodiment of this disclosure.

FIG. 5 is a schematic diagram of a structure of an electronic device (for example, a terminal device) 500 adapted to implement an embodiment of this disclosure. The terminal device in this embodiment of this disclosure may include but is not limited to a mobile terminal such as a mobile phone, a notebook computer, a digital broadcast receiver, a personal digital assistant (PDA), a tablet computer (PAD), a portable multimedia player (PMP), a vehicle-mounted terminal (such as a vehicle-mounted navigation terminal), and a fixed terminal such as a digital TV or a desktop computer. The electronic device shown in FIG. 5 is merely an example, and should not constitute any limitation on functions and a use scope of this embodiment of this disclosure.

As shown in FIG. 5, the electronic device 500 may include a processing apparatus (such as a central processing unit or a graphics processing unit) 501 that can perform various appropriate actions and processes according to a program stored in a read-only memory (ROM) 502 or a program loaded from a storage apparatus 506 to a random access memory (RAM) 503. The RAM 503 further stores various programs and data needed for an operation of the electronic device 500. The processing apparatus 501, the ROM 502, and the RAM 503 are connected to each other through a bus 504. An input/output (I/O) interface 505 is also connected to the bus 504.

Usually, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a loudspeaker, and a vibrator; a storage apparatus 508 including, for example, a magnetic tape and a hard disk; and a communications apparatus 509. The communications apparatus 509 may allow the electronic device 500 to perform wired or wireless communication with another device to exchange data. Although FIG. 5 shows the electronic device 500 with various apparatuses, it should be understood that it is not required to implement or have all the illustrated apparatuses. Alternatively, more or fewer apparatuses may be implemented or provided.

Particularly, according to this embodiment of this disclosure, the process described above with reference to the flowchart may be implemented as a computer software program. For example, an embodiment of this disclosure includes a computer program product that includes a computer program carried on a non-transient computer-readable medium. The computer program includes program code used to perform the method shown in the flowchart. In this embodiment, the computer program may be downloaded from a network and installed by using the communications apparatus 509, installed from the storage apparatus 508, or installed from the ROM 502. When the computer program is executed by the processing apparatus 501, the foregoing functions defined in the method in embodiments of this disclosure are implemented.

It should be noted that the computer-readable medium in this disclosure may be a computer-readable signal medium, a computer-readable storage medium, or a combination thereof. The computer-readable storage medium may be but is not limited to an electric, a magnetic, an optical, an electromagnetic, an infrared, or a semiconductor system, apparatus, or device, or any combination thereof. More specific examples of the computer-readable storage medium may include but are not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof. In this disclosure, the computer-readable storage medium may be any tangible medium containing or storing a program. The program may be used by an instruction execution system, apparatus, or device, or may be used in combination with an instruction execution system, apparatus, or device. In this disclosure, the computer-readable signal medium may include a data signal propagated in a baseband or propagated as part of a carrier, where the data signal carries computer-readable program code. Such a propagated data signal may take a variety of forms, including but not limited to an electromagnetic signal, an optical signal, or any appropriate combination thereof. The computer-readable signal medium may be alternatively any computer-readable medium other than the computer-readable storage medium. The computer-readable signal medium may send, propagate, or transmit a program used by the instruction execution system, apparatus, or device, or used in combination with the instruction execution system, apparatus, or device Program code included in the computer-readable medium may be transmitted by using any appropriate medium, including but not limited to an electric wire, an optical cable, RF (radio frequency), or any appropriate combination thereof.

In some implementations, a client and a server may perform communication by using any currently known or future developed network protocol, such as the hypertext transfer protocol (HyperText Transfer Protocol, HTTP), and may be interconnected with any form or medium of digital data communication (such as a communication network). Examples of the communication network include a local area network (“LAN”), a wide area network (“WAN”), an internet (such as the Internet), an end-to-end network (such as an ad hoc end-to-end network), and any currently known or future developed network.

The foregoing computer readable medium may be included in the foregoing electronic device, or may exist independently and is not assembled into the electronic device.

The computer-readable medium carries one or more programs. When the one or more programs are executed by the electronic device, the electronic device is enabled to: determine a plurality of stress amplitude ranges based on a plurality of preset discrete stress amplitudes; determine a plurality of dynamic S-N curves based on the plurality of discrete stress amplitudes and an attenuation coefficient of each stress amplitude range, where the attenuation coefficient of each stress amplitude range indicates a degradation degree of material performance of a steel box girder corresponding to each stress amplitude range relative to material performance of a steel box girder corresponding to a previous stress amplitude range; and predict a service life of a steel box girder based on the plurality of dynamic S-N curves, a plurality of monitored stress amplitudes of the steel box girder, and a plurality of monitoring cycle quantities in a one-to-one correspondence with the plurality of monitored stress amplitudes, where the plurality of monitored stress amplitudes are located in the plurality of stress amplitude ranges.

Computer program code for performing the foregoing operations in this disclosure may be written in one or more programming languages, or a combination thereof. The programming languages include but are not limited to an object-oriented programming language, such as Java, Smalltalk, and C++, and also include a conventional procedural programming language, such as a “C” language or a similar programming language. The program code may be executed entirely on a user computer, or some may be executed on a user computer as a separate software package, or some may be executed on a user computer while some are executed on a remote computer, or the code may be entirely executed on a remote computer or a server. When a remote computer is involved, the remote computer may be connected to a user computer by using any type of network, including a local area network (LAN) or a wide area network (WAN), or may be connected to an external computer (for example, connected by using an Internet service provider through the Internet).

The flowcharts and block diagrams in the accompanying drawings show the system architectures, functions, and operations that may be implemented by systems, methods, and computer program products according to various embodiments of this disclosure. In this aspect, each block in the flowcharts or the block diagrams may represent part of a module, a program segment or code, and part of the module, the program segment or the code includes one or more executable instructions configured to realize a specified logical function. It should be also noted that in some alternative implementations, the functions marked in the blocks may also be realized in an order different from those marked in the accompanying drawings. For example, two consecutive blocks may be actually executed substantially in parallel, or sometimes may be executed in a reverse order, depending on a function involved. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

The units involved in embodiments of this disclosure may be implemented in a software manner, or may be implemented in a hardware manner. In some cases, a name of a module does not constitute a limitation on the module.

The foregoing described functions in this specification may be performed at least partially by one or more hardware logic components. For example, non-restrictive examples of types of hardware logic components that may be used include a field programmable gate array (FPGA), an application specific integrated circuit (ASIC), application specific standard product (ASSP), a system-on-chip (SOC), and a complex programmable logic device (CPLD).

In the context of this disclosure, a machine-readable medium may be a tangible medium, and may include or store a program for use by an instruction execution system, apparatus, or device to use or in combination with an instruction execution system, apparatus, or device. The machine-readable medium may be a machine-readable signal medium or a machine-readable storage medium. The machine-readable medium may include but is not limited to an electronic, a magnetic, an optical, an electromagnetic, an infrared, or a semiconductor system, apparatus, or device, or any appropriate combination of the foregoing content. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any appropriate combination of the foregoing content.

Embodiments of this disclosure provide the method and the apparatus for predicting a service life of a steel box girder, the device, and the storage medium. The method includes: determining a plurality of stress amplitude ranges based on a plurality of preset discrete stress amplitudes; determining a plurality of dynamic S-N curves based on the plurality of discrete stress amplitudes and an attenuation coefficient of each stress amplitude range, where the attenuation coefficient of each stress amplitude range indicates a degradation degree of material performance of a steel box girder corresponding to each stress amplitude range relative to material performance of a steel box girder corresponding to a previous stress amplitude range; and predicting a service life of a steel box girder based on the plurality of dynamic S-N curves, a plurality of monitored stress amplitudes of the steel box girder, and a plurality of monitoring cycle quantities in a one-to-one correspondence with the plurality of monitored stress amplitudes, where the plurality of monitored stress amplitudes are located in the plurality of stress amplitude ranges. In embodiments of this disclosure, a dynamic S-N curve is established by introducing an attenuation coefficient, and damage accumulation of an orthotropic steel bridge plate is further calculated to predict a fatigue life of a steel box girder. In this way, a limitation of conventional technologies in a field of predicting a fatigue life of a steel box girder is overcome, to effectively and accurately predict the fatigue life of the steel box girder.

The foregoing descriptions are only preferred examples of this disclosure and explanations of the applied technical principles. The application scope involved in this disclosure is not limited to the technical solutions formed by the specific combination of the above technical features, and should also cover other technical solutions formed by any combination of the above technical features or their equivalent features without departing from the above applied concept, for example, a technical solution formed by mutual replacement between the foregoing features and technical features (not limited) having similar functions disclosed in this disclosure.

In addition, while operations are depicted in a particular order, this should not be construed as requiring these operations to be performed in the shown particular order or in a sequential order. In specific environments, multi-task and parallel processing may be advantageous. Similarly, although several specific implementation details are included in the foregoing descriptions, these should not be construed as limiting the scope of this disclosure. Some features described in the context of separate embodiments may also be implemented in combination in a single embodiment. On the contrary, various features described in the context of a single embodiment may also be implemented in a separate manner or in a manner of any appropriate sub-combination in a plurality of embodiments.

Although the subject matter has been described in a language specific to structural features and/or logical actions of a method, it should be understood that the subject matter defined in the appended claims is not necessarily limited to the specific features or actions described above. Rather, the specific features and actions described above are merely exemplary forms for implementing the claims.

What is claimed is:

1. A method for predicting a service life of a steel box girder, comprising:
determining a plurality of stress amplitude ranges based on a plurality of discrete stress amplitudes that are preset;
determining, based on each discrete stress amplitude and an original S-N curve, a current cycle quantity and a maximum cycle quantity that correspond to each discrete stress amplitude;
constructing a material attenuation performance function;
determining, based on the material attenuation performance function and the current cycle quantity and the maximum cycle quantity that correspond to each discrete stress amplitude, an attenuation coefficient of a stress amplitude range in which each discrete stress amplitude is located, wherein the attenuation coefficient of the stress amplitude range indicates a degradation degree of material performance of the steel box girder corresponding to the stress amplitude range relative to material performance of the steel box girder corresponding to a previous stress amplitude range;
calculating, based on an initial slope and an attenuation coefficient of each stress amplitude range, a slope of a dynamic S-N curve corresponding to each stress amplitude range, to determine a plurality of dynamic S-N curves, wherein the initial slope is a slope of the original S-N curve, and a point determined based on each discrete stress amplitude and the current cycle quantity corresponding to each discrete stress amplitude is located on a dynamic S-N curve corresponding to the stress amplitude range in which each discrete stress amplitude is located; and
predicting the service life of the steel box girder based on the plurality of dynamic S-N curves, a plurality of monitored stress amplitudes of the steel box girder, and a plurality of monitoring cycle quantities in a one-to-one correspondence with the plurality of monitored stress amplitudes, wherein the plurality of monitored stress amplitudes are located in the plurality of stress amplitude ranges.

2. The method for predicting a service life of a steel box girder according to claim 1, wherein constructing the material attenuation performance function comprises:
$$M ( n ) = ( C - D ) {e}^{- \frac{n}{{N}_{f}}} + D ,$$
wherein
M(n) is material attenuation performance, C is initial material performance, D is an attenuation function, N_{f} is a maximum cycle quantity corresponding to a stress amplitude, n is a current cycle quantity corresponding to the stress amplitude, 0≤n≤N_{f}, and e is a constant.

3. The method for predicting a service life of a steel box girder according to claim 2, wherein determining, based on the material attenuation performance function and the current cycle quantity and the maximum cycle quantity that correspond to each discrete stress amplitude, the attenuation coefficient of the stress amplitude range in which each discrete stress amplitude is located comprises:
$$β = \frac{M ( n ) - M ( {N}_{f} )}{M ( 0 ) - M ( {N}_{f} )} = \frac{[ ( C - D ) {e}^{\frac{- n}{{N}_{f}}} + D ] - [ ( C - D ) {e}^{- 1} + D ]}{C - [ ( C - D ) {e}^{- 1} + D ]} = \frac{{e}^{\frac{- n}{{N}_{f}}} - {e}^{- 1}}{1 - {e}^{- 1}} ,$$
wherein
β is the attenuation coefficient of the stress amplitude range in which the stress amplitude is located.

4. The method for predicting a service life of a steel box girder according to claim 1, wherein a slope change rate of two dynamic S-N curves corresponding to each stress amplitude range and a previous stress amplitude range is represented by an attenuation coefficient of each stress amplitude range.

5. The method for predicting a service life of a steel box girder according to claim 1, wherein predicting the service life of the steel box girder based on the plurality of dynamic S-N curves, the plurality of monitored stress amplitudes of the steel box girder, and the plurality of monitoring cycle quantities in the one-to-one correspondence with the plurality of monitored stress amplitudes comprises:
determining, from the plurality of dynamic S-N curves, at least one dynamic S-N curve corresponding to at least one target stress amplitude range comprising a monitored stress amplitude;
determining, based on each target stress amplitude range, a monitored stress amplitude in each target stress amplitude range, a monitoring cycle quantity corresponding to the monitored stress amplitude, and a slope of a dynamic S-N curve corresponding to each target stress amplitude range, a fatigue damage corresponding to each target stress amplitude range;
accumulating at least one fatigue damage corresponding to the at least one target stress amplitude range, to obtain a fatigue damage of the steel box girder within a unit time; and
predicting the service life of the steel box girder based on the fatigue damage of the steel box girder within the unit time.

6. The method for predicting a service life of a steel box girder according to claim 1, wherein before predicting the service life of the steel box girder based on the plurality of dynamic S-N curves, the plurality of monitored stress amplitudes of the steel box girder, and the plurality of monitoring cycle quantities in the one-to-one correspondence with the plurality of monitored stress amplitudes, the method further comprises:
determining a fatigue vulnerability region of the steel box girder;
obtaining a plurality of pieces of monitored data monitored by a sensor installed in the fatigue vulnerability region; and
performing preset algorithm processing on the plurality of pieces of monitored data, to obtain the plurality of monitored stress amplitudes and the plurality of monitoring cycle quantities in the one-to-one correspondence with the plurality of monitored stress amplitudes.

7. The method for predicting a service life of a steel box girder according to claim 1, wherein determining the plurality of stress amplitude ranges based on the plurality of preset discrete stress amplitudes comprises:
sorting the plurality of discrete stress amplitudes in sequence by numerical magnitude; and
in a sorting result, using every two adjacent discrete stress amplitudes as boundary values of one stress amplitude range, to obtain the plurality of stress amplitude ranges.

8. An electronic device, comprising:
one or more processors; and
a memory, configured to store one or more programs, wherein
when the one or more programs are executed by the one or more processors, the one or more processors are enabled to implement the method for predicting a service life of a steel box girder according to claim 1.

9. A computer-readable storage medium, wherein the computer-readable storage medium stores a computer program, and when the program is executed by a processor, the method for predicting a service life of a steel box girder according to claim 1 is implemented.
